(19) United States
(12) Patent Application Publication
(10) Pub. No.: US 2026/0170269 A1
(43) Pub. Date: Jun. 18, 2026

(54) MULTIMODAL MODEL POST TRAINING

(71) Applicant: NVIDIA CORPORATION, Santa Clara, CA (US)

(72) Inventors: Zhiding YU, Santa Clara, CA (US); Zhiqi LI, Shanghai (CN); Guo CHEN, Jiangsu (CN); Shilong LIU, San Jose, CA (US); Shihao WANG, Beijing (CN); Vibashan VISHNUKUMAR SHARMINI, Baltimore, MD (US); Shiyi LAN, San Jose, CA (US); Hao ZHANG, Santa Clara, CA (US); Yilin ZHAO, Santa Clara, CA (US); Subhashree RADHAKRISHNAN, San Jose, CA (US); Nai Chen CHANG, Hillsborough, CA (US); Karan SAPRA, San Jose, CA (US); Amala Sanjay DESHMUKH, Mountain View, CA (US); Tuomas RINTAMAKI, Santa Clara, CA (US); Matthieu LE, San Francisco, CA (US); De-An HUANG, Davis, CA (US); Jose Manuel ALVAREZ LOPEZ, Mountain View, CA (US); Bryan CATANZARO, Los Altos Hills, CA (US); Jan KAUTZ, Lexington, MA (US); Andrew J. TAO, San Francisco, CA (US); Guilin LIU, San Jose, CA (US)

(21) Appl. No.: 19/322,433

(22) Filed: Sep. 8, 2025

Related U.S. Application Data
(60) Provisional application No. 63/733,405, filed on Dec. 12, 2024.

(51) Int. Cl. G06F 40/40; G06V 10/26; G06V 10/77; G06V 10/774; G06V 10/80

(52) U.S. Cl. CPC G06F 40/40; G06V 10/26; G06V 10/7715; G06V 10/774; G06V 10/806

(57) ABSTRACT

The disclosed method for training a multimodal model includes performing one or more first operations to train a connector disposed between one or more vision encoders and a language model included in the multimodal model; performing one or more second operations to train the multimodal model using a first dataset; and performing one or more third operations to train the multimodal model using a second dataset to generate a trained multimodal model, where the second dataset is smaller than the first dataset, and where the trained multimodal model processes at least one of an input image or an input text to generate an output text.

### CROSS-REFERENCE TO RELATED APPLICATIONS

This application claims priority benefit of the United States Provisional Patent Application titled, “TECHNIQUES FOR VISION-LANGUAGE MODEL POST TRAINING,” filed on Dec. 12, 2024, and having Ser. No. 63/733,405. The subject matter of this related application is hereby incorporated herein by reference.

### BACKGROUND

### Technical Field

Embodiments of the present disclosure relate generally to computer science, artificial intelligence, and machine learning, and more specifically, to multimodal model post training.

### Description of the Related Art

Multimodal models are machine learning models designed to process and generate information across multiple types of data, such as text and images. Multimodal models are unlike traditional language models, which can only process text and generate text outputs. The ability to understand and relate information from different modalities enables multimodal models to be applied to sophisticated applications, such as virtual assistants, content creation tools, automated medical diagnostics, image-based search, visual question answering, recommendation engines, augmented reality experiences, medical diagnosis support, content moderation, and robotics, among other things.

Conventional multimodal models build upon large language models (LLMs) by processing and integrating multiple types of data through specialized components, including modality-specific encoders and an LLM. The encoders are preprocessing units that transform raw inputs, such as images and text, into structured representations that can be understood by the LLM. Then, the LLM can process the structured representations to generate outputs, infer relationships between modalities, and perform reasoning tasks, among other things.

One drawback of the above approach for implementing multimodal models is that conventional multimodal models can generate outputs that are incorrect for images and text that are input into those multimodal models. For example, a multimodal model could respond incorrectly or “hallucinate” an answer to a text question about an image that is input into the multimodal model. As another example, a multimodal model could fail to correctly perform various tasks, such as optical character recognition (OCR) or document analysis.

Another drawback of conventional multimodal models is that such models require considerable time to train. Training is the process of teaching a multimodal model to generate output text based on training data. A conventional multimodal model is typically trained through the two-step process of training a connector within the multimodal model that connects the encoders and the LLM, described above, and then training the full multimodal model. However, the two-step process for training multimodal models is oftentimes very time consuming.

As the foregoing illustrates, what is needed in the art are more effective techniques for implementing multimodal models.

### SUMMARY

One embodiment of the present disclosure sets forth a computer-implemented method for training a multimodal model. The method includes performing one or more first operations to train a connector disposed between one or more vision encoders and a language model included in the multimodal model. The method further includes performing one or more second operations to train the multimodal model using a first dataset. In addition, the method includes performing one or more third operations to train the multimodal model using a second dataset to generate a trained multimodal model. The second dataset is smaller than the first dataset. The trained multimodal model processes at least one of an input image or an input text to generate an output text.

Another embodiment of the present disclosure sets forth a computer-implemented method for processing data. The method includes splitting an image into a plurality of tiles. The method further includes encoding each of the plurality of tiles using a plurality of vision encoders to generate a plurality of vision features, where the plurality of vision encoders are trained to perform different tasks, generating one or more tokens based on the plurality of vision features. In addition, the method includes processing the one or more tokens using a language model to generate a text output.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, multimodal models, such as vision-language models, can be trained to generate correct responses to more user inputs relative to what can be generated using some conventional multimodal models. In addition, the disclosed techniques permit multimodal models to be trained more efficiently than conventional techniques for training multimodal models. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the vision-language model (VLM) of FIG. 1, according to various embodiments;

FIG. 5 is a more detailed illustration of the data generator of FIG. 1, according to various embodiments;

FIG. 6 is a more detailed illustration of the model trainer of FIG. 1, according to various embodiments;

FIG. 7A illustrates exemplar knapsacks of a naive greedy knapsack approach, according to the prior art;

FIG. 7B illustrates exemplar knapsacks of a balanced knapsack technique, according to various embodiments;

FIG. 8 illustrates exemplar inputs into and outputs of a VLM, according to various embodiments;

FIG. 9 illustrates additional exemplar inputs into and an output of a VLM, according to various embodiments;

FIG. 10 illustrates additional exemplar inputs into and an output of a VLM, according to various embodiments;

FIG. 11 is a flow diagram of method steps for generating training data, according to various embodiments;

FIG. 12 is a flow diagram of method steps for training a VLM, according to various embodiments; and

FIG. 13 is a flow diagram of method steps for processing inputs using a trained VLM, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating training data and training multimodal models. In some embodiments, a model trainer trains a vision-language model (VLM) that includes an image splitting module that splits an input image into tiles, multiple vision encoders that encode the tiles into vision features, a feature concatenation module that concatenates the vision features, a connector that converts the concatenated features into language embeddings, and a large language model (LLM) that takes as input the language embeddings and input text and that generates a natural language output. Although described herein primarily with respect to VLMs that include LLMs as a reference example, in some embodiments, techniques disclosed herein can be applied to any technically feasible multimodal models. In some embodiments, a data generator first collects and refines data from various sources to generate training data for training a VLM. The refinements can include filtering the data, selecting subsets from the data, augmenting the data, and/or formatting the data. After the training data is generated, the model trainer performs training of the VLM in three stages. In the first stage of training, referred to herein as stage 1 training, the model trainer trains a connector of the VLM while keeping other portions of the VLM fixed. In the second stage of training, referred to herein as stage 1.5 training, the model trainer trains the full VLM with large-scale diverse data. In the third stage of training, referred to herein as stage 2 training, the model trainer trains the full VLM using a high-quality visual instruction tuning dataset. The training also employs a balance-aware greedy knapsack technique that prioritizes balanced length distribution over packing efficiency to improve the speed of training. Once trained, the VLM can take as input text and/or an image and output a natural language response.

The techniques for training and deploying VLMs have many real-world applications. For example, those techniques could be used to train VLMs that are used in virtual assistants, content creation tools, automated medical diagnostics, image-based search, visual question answering, recommendation engines, augmented reality experiences, medical diagnosis support, content moderation, and robotics, among other things.

The above examples are not in any way intended to be limiting. As persons skilled in the art will appreciate, as a general matter, the techniques for training VLMs can be implemented in any suitable application.

### System Overview

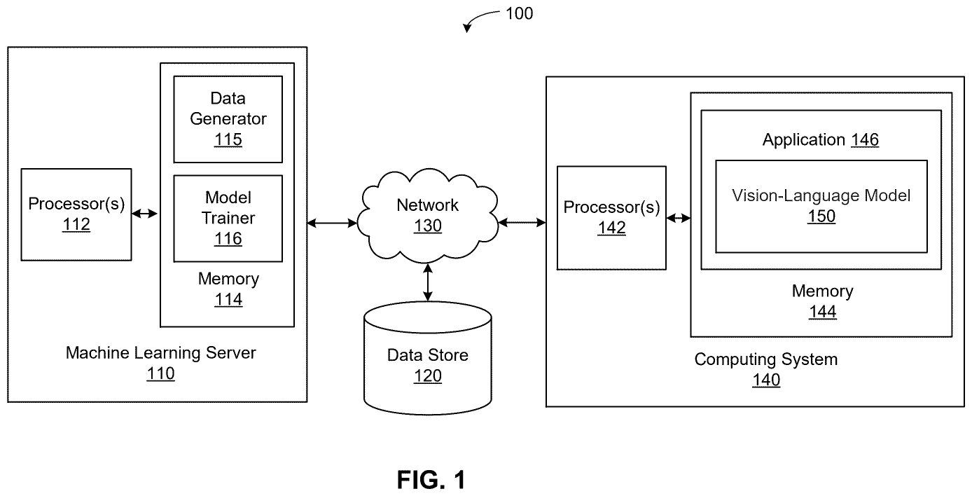

FIG. 1 illustrates a block diagram of a computer-based system 100 configured to implement one or more aspects of at least one embodiment. As shown, the system 100 includes, without limitation, a machine learning server 110, a data store 120, and a computing device 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor 112 receives user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

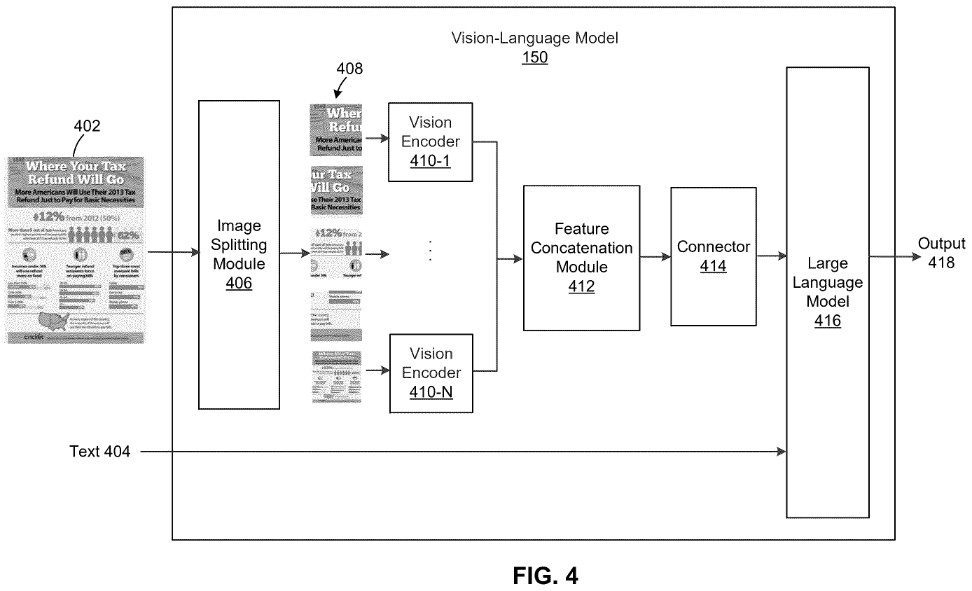

In some embodiments, the model trainer 116 is configured to train one or more machine learning models, including a vision-language model (VLM) 150 that is trained to process text and image inputs. Techniques for training VLMs are discussed in greater detail below in conjunction with FIGS. 4-12. Training data and/or trained machine learning models, including the VLM 150, can be stored in the data store 120, or elsewhere. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

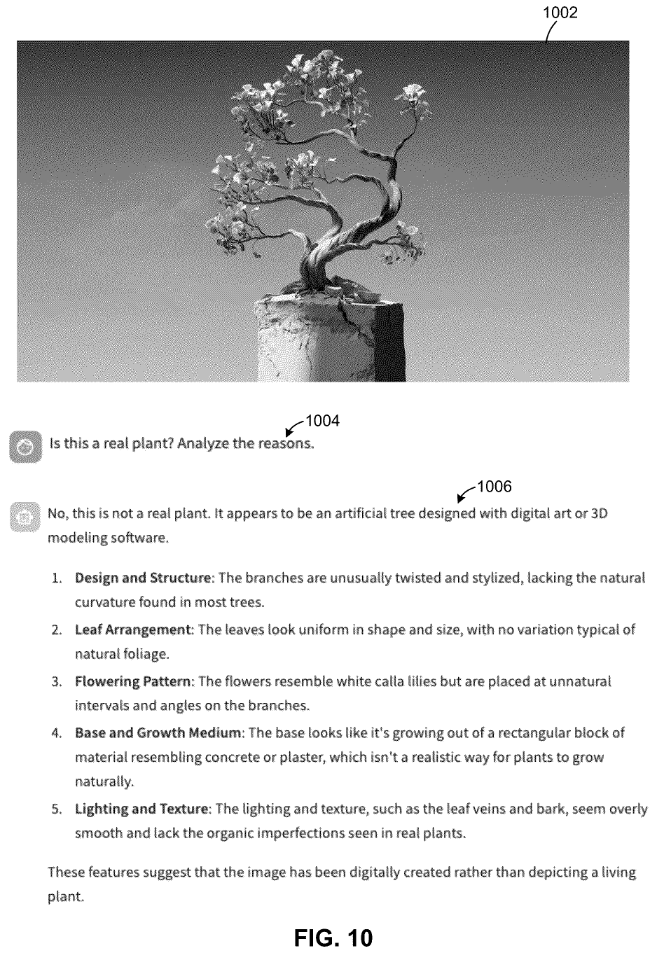

As shown, an application 146 that uses the trained VLM 150 is stored in a memory 144, and executes on processor(s) 142, of the computing device 140. The memory 144 and the processor(s) 142 may be similar to the memory 114 and the processor(s) 112, respectively, of the machine learning server, described above. In some embodiments, the application 146 can be any technically feasible application that uses the trained VLM 150. For example, the application 146 could be an application for a virtual assistant, content creation tool, automated medical diagnostic, image-based search, visual question answering, recommendation engine, augmented reality experience, medical diagnosis support, content moderation, robotics, etc. The application 146 is discussed in greater detail below in conjunction with FIGS. 4 and 10.

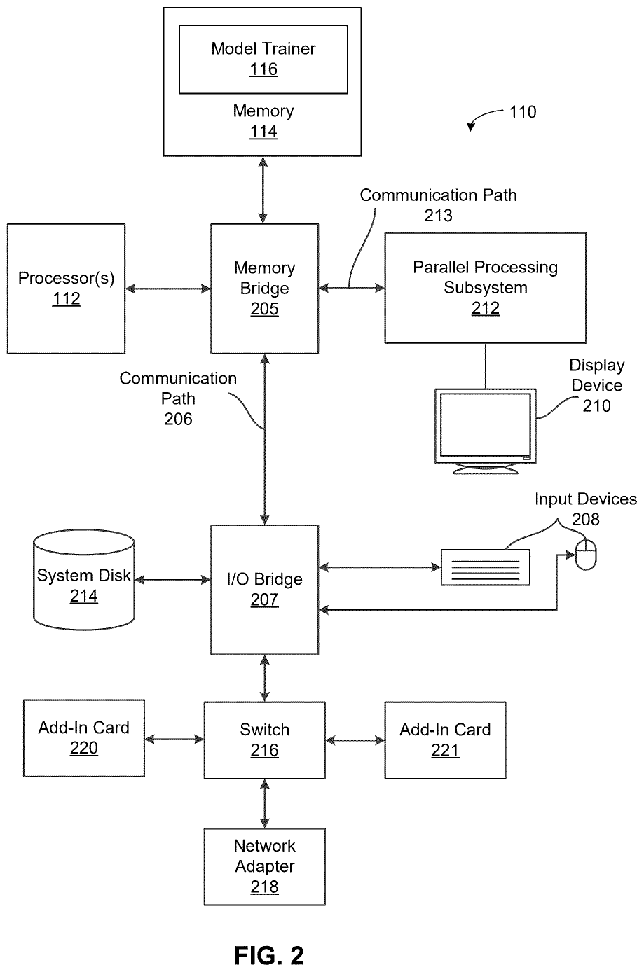

FIG. 2 is a block diagram illustrating the machine learning server 110 of FIG. 1 in greater detail, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network. In some embodiments, the machine learning server 110 can include one or more similar components as the machine learning server 110.

In various embodiments, the machine learning server 110 includes, without limitation, the processor(s) 112 and the memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, the system memory 114 includes the model trainer 116. Although described herein primarily with respect to the model trainer 116 and, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor(s) 112 and other connection circuitry on a single chip to form a system on a chip (SoC).

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

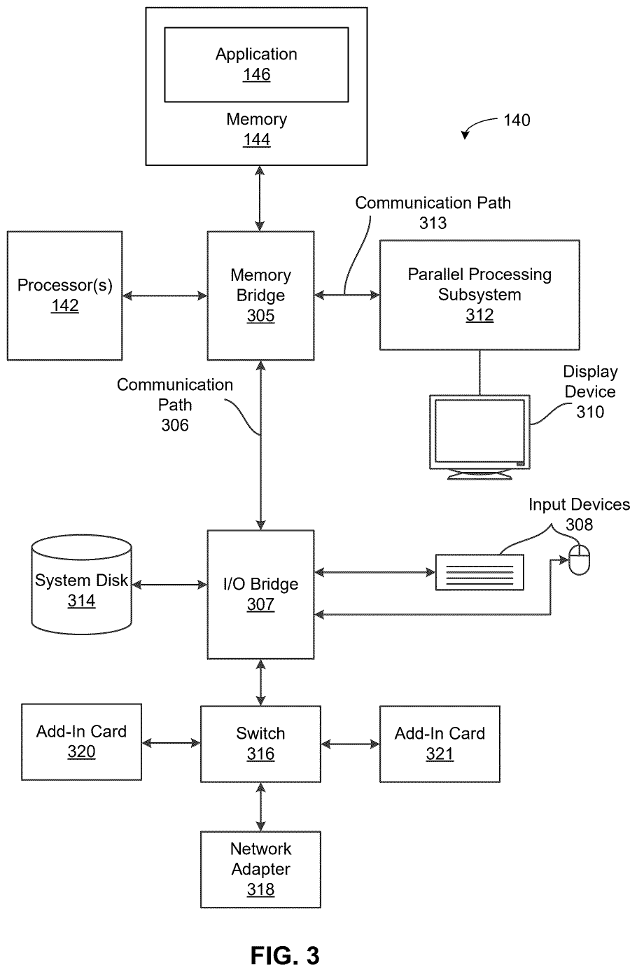

FIG. 3 is a block diagram illustrating the computing device 140 of FIG. 1 in greater detail, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network. In some embodiments, the machine learning server 110 can include one or more similar components as the computing device 140.

In various embodiments, the computing device 140 includes, without limitation, the processor(s) 142 and the memory(ies) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 308, but may receive equivalent input information by receiving commands (e.g., responsive to one or more inputs from a remote computing device) in the form of messages transmitted over a network and received via the network adapter 318. In some embodiments, switch 316 is configured to provide connections between I/O bridge 307 and other components of the computing device 140, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a Northbridge chip, and I/O bridge 307 may be a Southbridge chip. In addition, communication paths 306 and 313, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations. System memory 144 includes at least one device driver configured to manage the processing operations of the one or more PPUs within parallel processing subsystem 312. In addition, the system memory 144 includes the Application 146. Although described herein primarily with respect to the Application 146, techniques disclosed herein can also be implemented, either entirely or in part, in other software and/or hardware, such as in the parallel processing subsystem 312.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, the processor(s) 142 issues commands that control the operation of PPUs. In some embodiments, communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 312, may be modified as desired. For example, in some embodiments, system memory 144 could be connected to the processor(s) 142 directly rather than through memory bridge 305, and other devices may communicate with system memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Multimodal Model Post Training

FIG. 4 is a more detailed illustration of the VLM 150 of FIG. 1, according to various embodiments. As shown, the VLM 150 includes, without limitation, an image splitting module 406, a plurality of vision encoders 410, a feature concatenation module 412, a connector 414, and an LLM 416. In some embodiments, the VLM 150 can be implemented as an artificial neural network that includes multiple layers of neurons. Although described herein primarily with respect to VLMs that include LLMs as a reference example, in some embodiments, techniques disclosed herein can be applied to any technically feasible multimodal models, such as multimodal models that include other types of language models that are capable of processing natural language inputs and generating natural language outputs.

In operation, the VLM 150 can receive as input an image, shown as input image 402, and/or natural language text, shown as input text 404. The image splitting module 406 splits the image 402 into tiles 408. The vision encoders 410 encode the tiles 408 into vision features. The feature concatenation module 412 concatenates the vision features, and the connector 414 converts the concatenated features into language embedding tokens in a word embedding space of the LLM 416. The embedding tokens and input text 404 are input into the LLM 416, which generates a natural language output 418.

In some embodiments, each of the vision encoders 410 is a pre-trained vision encoder for a specific task. The vision encoders 410 are included in the VLM 150 to allow the LLM 416 to “see” various aspects of the image 402. Each of the vision encoders 410 outputs vision features. In some embodiments, the vision encoders 410 can be pre-trained for different tasks, such as a vision language alignment task, a text recognition task, an object detection task, a semantic segmentation task, and/or an optical character recognition (OCR) task, and the vision encoders 410 can also be pre-trained to process images having the same or different resolutions. The multiple vision encoders 410 that are pre-trained for different tasks can perform better for such pre-trained tasks when used in the VLM 150. Accordingly, the VLM 150 that uses the vision encoders 410 can perform better across the different tasks than a VLM that includes only a single vision encoder.

The feature concatenation module 412 concatenates the vision features that are output by the vision encoders 410 to generate fused vision features. For example, in some embodiments, the feature concatenation module 412 can perform a channel-wise concatenation of the vision features that are output by the vision encoders 410 to generate the fused vision features. In some other embodiments, rather than a concatenation, any technically feasible fusion of the vision features can be performed to generate the fused vision features. Accordingly, the vision encoders 410 and the feature concatenation module 412 implement a channel-concatenated mixture of vision encoders.

The connector 414 converts the fused vision features into language embedding tokens in a word embedding space of the VLM 150. In some embodiments, the connector 414 can be implemented as a learnable multi-layer perceptron (MLP) layer.

The LLM 416 is a machine learning model configured to process and generate natural language text. The LLM 416 can include a deep learning architecture, such as a transformer-based neural network, that analyzes and predicts language patterns, enabling applications like natural language understanding, text generation, and contextual reasoning. In some embodiments, the LLM 416 can be pre-trained on diverse textual corpora. Given the language embedding tokens output by the connector 414 and the input text 404 (or language embedding tokens generated from the input text 404), the LLM 416 generates a natural language output (e.g., output 418).

More specifically, in some embodiments, the VLM 150 includes a vision-centric design where both dynamic tiling and a mixture of vision encoders (MoVE) in one unified is employed in a single design. Each image tile generated by the image splitting module 406 is encoded by channel-concatenated MOVE, therefore allowing high-resolution input from tiling while maintaining the robust perception from MOVE. For example, in some embodiments, SigLIP (Sigmoid Loss for Language Image Pre-training), which is a vision transformer (ViT) encoder, and ConvNeXt-XXLarge (Convolutional Neural Network Next-XXLarge) convolutional encoder, can be used as the vision encoders 410. Additionally, to handle arbitrarily high-resolution images, the image splitting module 406 generates image tiles from input images (e.g., input image 402). In such cases, the input resolution of every image tile of SigLIP could be 448×448, while the input size of ConvNext could be 512×512. To make sure SigLIP and ConvNext output the same number of image tokens, PixelShuffle can be used to conduct a 2× downsampling on the image features from SigLIP, resulting in a feature shape of 16×16, matching the output size of ConvNext (32×downsampling of input). The feature concatenation module 412 then concatenates these features along the channel dimension, and the concatenated features are aligned with the LLM 146 via the connector 414 that is an MLP layer.

The VLM 150 can be deployed for use in any technically feasible application, such as the application 146 of FIG. 1. When the application 146 receives an image and a text input, such as an instruction or question, the application 146 inputs the image and text input into the VLM 150. Given such inputs, the VLM 150 generates an output, which can then be displayed or otherwise output (e.g., as audio) and/or processed by the application 146. For example, in some embodiments, the application 146 can display the output of the VLM 150 via a user interface (UI) and a display device. As another example, in some embodiments, the application 146 can convert the output of the VLM 150 to audio using a text-to-speech model and then output the audio via a speaker device.

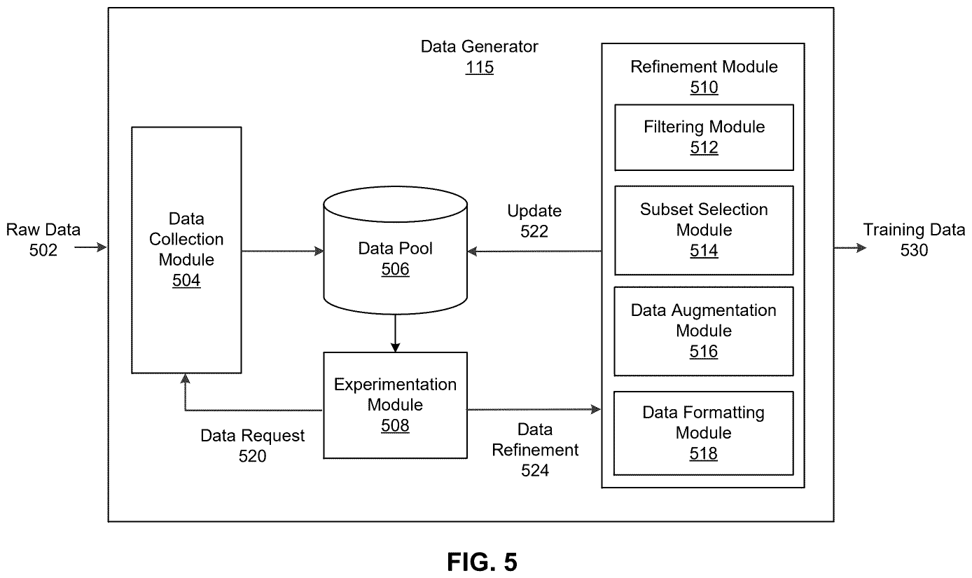

FIG. 5 is a more detailed illustration of the data generator 115 of FIG. 1, according to various embodiments. As shown, the data generator 115 includes, without limitation, a data collection module 504, a data pool 506, an experimentation module 508, and a refinement module 510. The refinement module 510 includes, without limitation, a filtering module 512, a subset selection module 514, a data augmentation module 516, and a data formatting module 518.

In operation, the data collection module 504 collects raw data 502 from one or more data sources, performs relevance filtering and merging on the raw data 502, and stores the resulting data in the data pool 506. For example, the data sources could include publicly available online data sources and/or proprietary data sources. The capability of a VLM is strongly correlated with the diversity of data used to train the VLM. As such, collecting data that is as diverse as possible is beneficial and can be achieved using two main strategies in some embodiments. First, passive gathering can be used to either manually or automatically monitor the latest related datasets and add the related databases to a candidate list. Second, proactive searching can be used to either manually or automatically address the bucket effect. In some embodiments, the data collection module 504 can also convert data that does not include questions and answers (QAs) to visual question answer (VQA) data using rules or automatically labeling (auto-labeling) tools.

In some embodiments, to reduce training costs, the data collection module 504 can avoid performing ablation for each dataset individually. Instead, the data collection module 504 can perform a similarity-based search in which datasets with similar domains are added in batches to the data pool 506 when meeting the following criteria: (1) maintaining overall accuracy without noticeable regression for every considered benchmark, and (2) introducing meaningful diversity to the current domains. To help quantify the diversity, the data collection module 504 can use a similarity score metric to measure the relevance between a new data source and the current data pool as follows:

$${S}_{k} = \frac{1}{N} {\sum }_{i = 1}^{N} {max}_{1 \leq j \leq {M}_{k}} ( Sim ( {I}_{i} , {I}_{j} ) \times Sim ( {T}_{i} , {T}_{j} ) ) , \qquad ( 1 )$$

where i is the index of a new data source with N samples, and j is the index of the existing pool with M samples, with k denoting the data category. In some embodiments, similarity scores are only computed within the same category, as inter-category similarity is generally low. In equation (1), image embeddings Iᵢ and Iⱼ can be generated from SSCD (self-supervised descriptor for copy detection), and text embeddings Tᵢ and Tⱼ can be generated from a sentence transformer, such as all-mpnet-base-v2. The similarity score between samples is the product of an image similarity and a text similarity. The metric of equation (1) shows most sources have low similarity, with a few high-similarity samples removed as duplicates.

The experimentation module 508 performs tests using a trained VLM (e.g., VLM 150). In some embodiments, the tests can include one or more benchmark tests that test the performance of the VLM at various tasks, such as question answering, solving math problems, optical character recognition, etc. Results of the tests can be used to determine whether additional data is required for training the VLM and/or whether data refinement is required to generate refined data for training the VLM. In some embodiments, for each update 522 of the data pool 506, the experimentation module 508 generates error analysis to identify model weaknesses, and targeted searches are performed, either manually or automatically, for new data to address the weaknesses.

Illustratively, if additional data is required, then the experimentation module 508 makes a data request 520 to the data collection module 504. If data refinement is required, then the experimentation module 508 makes a data refinement request 524 to the refinement module 510.

The refinement module 510 is configured to refine training data used to train a VLM (e.g., the VLM 150). As described, the refinement module 510 includes the filtering module 512, the subset selection module 514, the data augmentation module 516, and the data formatting module 518. The filtering module 512 is configured to filter out low-quality samples from training data. Public datasets often include many low-quality samples. Experience has shown that most low-quality cases belong to the following categories, which can be used as filtering criteria: (1) mismatching question-answer pair, (2) irrelevant image-question pair with unrelated image, (3) repeated texts, (4) numeric formatting issues, such as excessive decimal precision or overly precise numerical answers lacking corresponding information in the image. As most low-quality samples are generated from synthesis, the low-quality samples often present characteristics making them distinguishable for removal through rule-based filtering, which the filtering module 512 can perform.

The subset selection module 514 is configured to select subsets of samples from the data sources, thereby limiting the number of samples and/or oversampling from certain sources and balancing the number of samples so that no one source is overrepresented in the training data. In some embodiments, the subset selection module 514 can select relatively optimal subsets of data, which enables high-quality training of a VLM. For example, in some embodiments, subset selection module 514 can limit the number of samples from each source to no more than a predefined number K (e.g., 350K). In some embodiments, the subset selection module 514 adopts two main principles: (1) subset quality determination, and (2) K-means clustering selection. With respect to the subset quality determination, data source diversity and distribution determine the sample quantity. Autolabeled data sources are featured by larger sizes, but often include errors and lack diversity. By contrast, manually labeled datasets are often smaller. Accordingly, datasets with larger original sizes can be generally applied with smaller sampling ratios by the subset selection module 514. Further, in some embodiments, in stage 2 of training that is discussed in greater detail below, the average size per data source can be around 20K, with the largest subset having around 263K samples. With respect to the k-means clustering selection, once the subset size is determined, the next step is to select the samples. Conventional approaches often use random selection, which is suboptimal. For example, in chart data, histogram samples are more frequent than other types such as line charts or pie charts, and random sampling would not ensure balance across these types of data. To address this issue, in some embodiments, the subset selection module 514 can perform unsupervised K-means clustering on SSCD image embeddings, where samples with similar chart types are clustered closer, allowing for target data selection, such as including all the line and pie chart samples as needed. While K-means clustering using SSCD image embeddings performs poorly on natural scene images, K-means clustering using SSCD image embeddings excels with mathematical, medical, and document-based data.

The data augmentation module 516 is configured to generate additional training data from existing training data. In some embodiments, the data augmentation module 516 mines the rich information from input images that are not fully present in existing QA annotations. In order to mine the potentially useful information from image space, the data augmentation module 516 can use a pre-trained VLM to generate fine-grained descriptions of the images. In some embodiments, the data augmentation module 516 can use a pre-trained VLM to add CoT (Chain-of-Thought) explanations. In some embodiments, the data augmentation module 516 can perform rule-based QA generation. In some embodiments, the data augmentation module 516 can use a pre-trained VLM to expand short answers into longer responses.

The data formatting module 518 is configured to reformat data into standard format(s). Transforming data into a correct format is also a beneficial step in data preparation. In some embodiments, the data formatting module 518 can operate under the basic principles of: “same task, similar format; different tasks, clearly distinct formats.” In some embodiments, the data formatting includes, but is not limited to: (1) removing unnecessary decorations, such as unnecessary notations in equations; and (2) appending more specific instructions by adding detailed instructions to original instructions (e.g., appending “Provide a short answer” to brief responses helps prevent a model from becoming an “answering machine” that is used to giving short answers”).

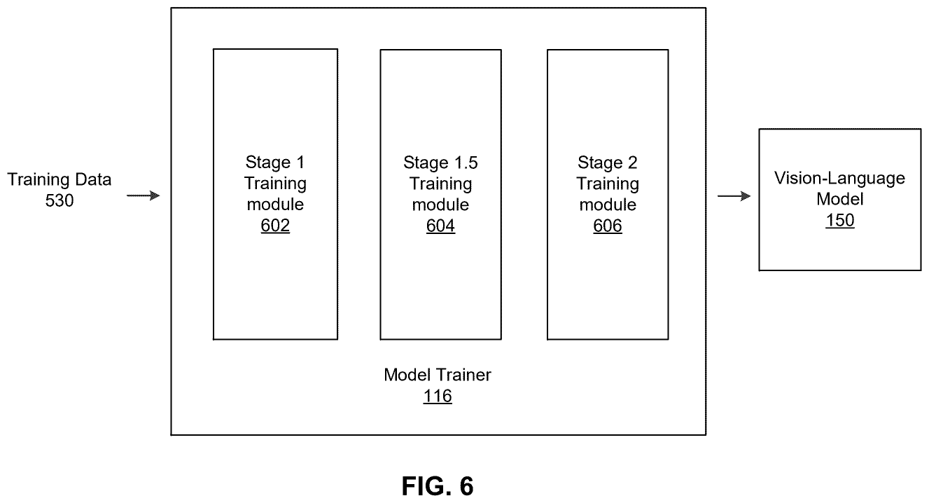

FIG. 6 is a more detailed illustration of the model trainer 116 of FIG. 1, according to various embodiments. As shown, the model trainer 116 includes, without limitation, a stage 1 training module 602, a stage 1.5 training module 604, and a stage 2 training module 606. In operation, the model trainer 116 receives training data 530 generated by the data generator 115. The model trainer 116 uses the training data 530 to train the vision language model 150 in three stages: stage 1, stage 1.5, and stage 2.

The stage 1 training module 602 performs stage 1 of training. During stage 1, the stage 1 training module 602 trains the connector 414 of the VLM 150. The stage 1.5 training module 604 performs stage 1.5 of training. During stage 1.5, stage 1.5 training module 604 trains the full VLM 150 with large-scale diverse data. The stage 2 training module 606 performs stage 2 of training. During stage 2, the stage 2 training module 606 trains the full VLM 150 using a high-quality visual instruction tuning dataset. In addition, the stage 2 training module 606 can perform tests using the VLM 150 that has been trained to determine whether to continue stage 2 of training. If the stage 2 training module 606 determines to continue training, then the stage 2 training module 606 adjusts the training data based on the test results and performs stage 2 training again using the adjusted training data.

In some embodiments, all data sources intended for visual instruction are used in stage 1.5, which can include introducing several other datasets that are not used in stage 2. In some embodiments, stage 1.5 can utilize a visual instruction dataset, and stage 2 can utilize a visual instruction tuning dataset. For example, in some embodiments, stage 2 can utilize training data belonging to the following categories: captioning and knowledge, mathematics, science, chart and table, naïve OCR, OCR QA, grounding and counting, general VQA, and text-only. In such cases, stage 1.5 can utilize the same training data, as well as additional training data belonging to the captioning and knowledge, grounding and counting, and text-only categories.

Training stage 2 based on stage 1.5 enables rapid iteration on a high-performance foundation. In particular, after the large scale training of stage 1.5, stage 2 only requires a smaller training data set and can iterate faster than if stage 1.5 were not performed. In addition, the effective conclusions obtained from stage 2 can be used to update stage 1.5, further driving improvements in model performance.

In some embodiments, to further speed up training, model trainer 116 can perform data packing. Data packing speeds up training by concatenating shorter samples, reducing padding use. Experience has shown that using packing can accelerate training by 2-3 times. One step in packing is arranging/short samples of varying lengths into M long samples without exceeding a maximum length. Conventional frameworks such as LLaMa-Factory (Large Language Model Meta A-Factor) use a naïve greedy knapsack algorithm, which often produces packs with uneven length distributions in which long and short samples are grouped separately, which is not desirable for model training. In some embodiments, the model trainer 116 can instead perform a balance-aware greedy knapsack technique that creates packs with a more uniform length distribution, ensuring that each pack contains both long and short samples. The balance-aware greedy knapsack technique prioritizes balanced length distribution over packing efficiency, helping balance loss weights between long and short samples. In some embodiments, the balance-aware greedy knapsack technique can sort samples in a training data set, initialize knapsacks, and then distribute the samples across the knapsacks, as shown in Algorithm 1.

Algorithm 1. Balance-aware greedy knapsack method

```
def balanced_greedy_knapsack(samples, L):
  # Step 1: Sort the samples
  samples.sort(reverse=True)
  total_length = sum(samples)
  min_knapsacks = (total_length + L − 1) // L
  # Step 2: Initialize knapsacks
  knapsacks=[[ ] for _ in range(min_knapsacks)]
  knapsack_lengths = [0] * min_knapsacks
  # Step 3: Distribute samples across knapsacks
  ks_index = 0
  sample_index = 0
  while sample_index < len(samples):
    length = samples[sample_index]
    if knapsack_lengths[ks_index]+length<=L:
      knapsacks[ks_index].append(length)
      knapsack_lengths[ks_index] +=
      length
      sample_index += 1
    else:
      knapsacks.append([ ])
      knapsack_lengths.append(0)
      ks_index = argmin(knapsack_lengths)
  return knapsacks
```

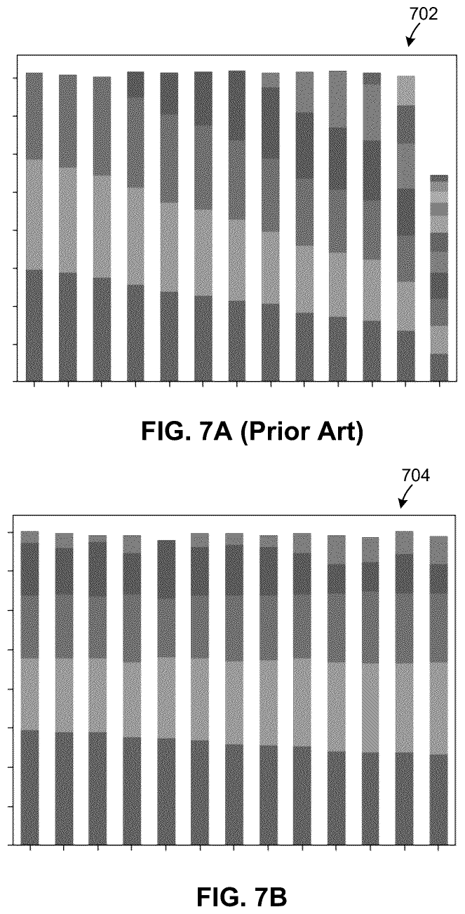

FIG. 7A illustrates exemplar knapsacks of a naïve greedy knapsack approach, according to the prior art. As shown, a chart 702 depicts a number of knapsacks resulting from the naïve greedy knapsack approach on the x-axis and a length on the y-axis. Illustratively, the naïve greedy knapsack approach leads to an uneven distribution of lengths of data samples, which can be wasteful of computational resources that are required to find shorter and longer data samples.

FIG. 7B illustrates exemplar knapsacks of a balanced knapsack technique, according to various embodiments. As shown, a chart 704 depicts a number of knapsacks resulting from the balanced knapsack technique on the x-axis and a length on the y-axis. Illustratively, the balanced knapsack technique leads to more balanced distributions of lengths of samples within every knapsack. Accordingly, the balanced knapsack technique can save computational resources relative to the naïve greedy knapsack approach.

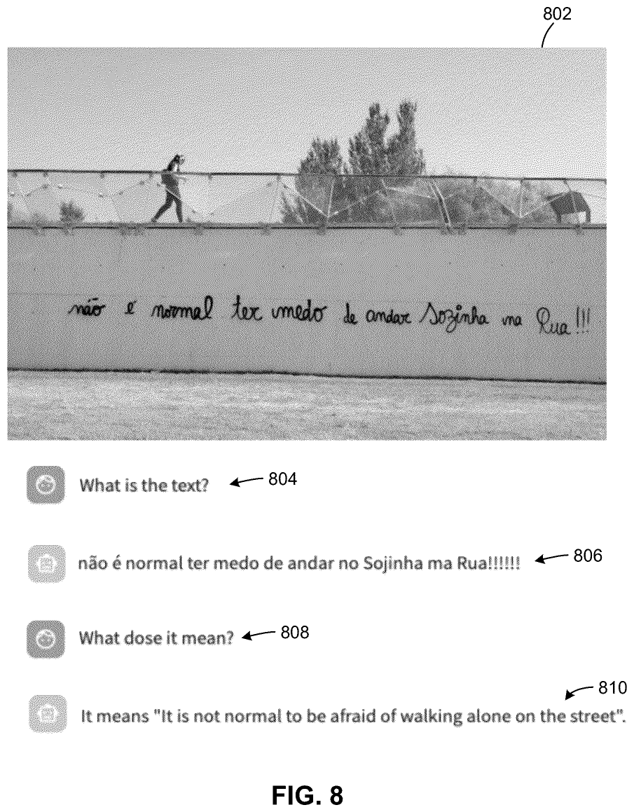

FIG. 8 illustrates exemplar inputs into and outputs of VLM 150, according to various embodiments. As shown, given an input image 802 and an input text 804 of “What is the text” in the input image 802, the VLM 150 is able to recognize text in the input image 802 and generate a response 806. In response to another input text 808 asking what the recognized text in the input image 802 means, the VLM 150 is able to translate the recognized text and generate a response 810 explaining what the recognized text means.

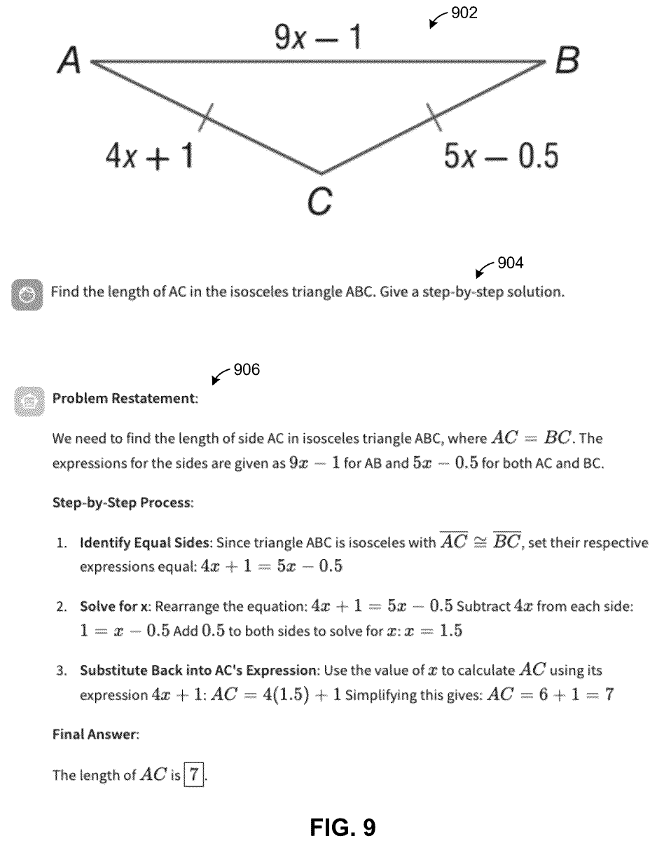

FIG. 9 illustrates additional exemplar inputs into and an output of VLM 150, according to various embodiments. As shown, given an input image 902 and an input text 904 asking the VLM 150 to solve a math problem using the input image 902, the VLM 150 is able to generate a response 906 that solves the math problem and provides a step-by-step solution requested by the input text 904.

FIG. 10 illustrates additional exemplar inputs into and an output of VLM 150, according to various embodiments. As shown, given an input image 1002 and an input text 1004 asking the VLM 150 to determine whether a plant in the input image 1002 is real, the VLM 150 is able to generate a response 1006 answering that the plant is not a real plant and providing a reasoned analysis requested by the input text 1004.

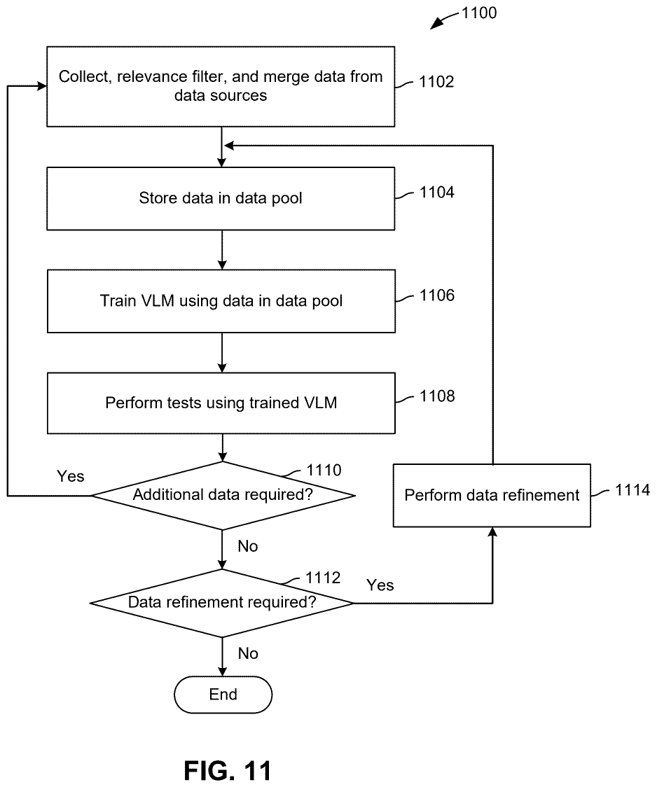

FIG. 11 is a flow diagram of method steps for generating training data, according to various embodiments. Although the method steps are described in conjunction with the embodiments of FIGS. 1-10, persons skilled in the art will understand that any system configured to perform the method steps in any order falls within the scope of the present embodiments.

As shown, a method 1100 begins at step 1102, where the data generator 115 collects, relevance filters, and merges data from one or more data sources. As described, the data collection module 504 of the data generator 115 can collect raw data from one or more data sources, such as publicly available and/or proprietary sources. The data collection module 504 can then perform relevance filtering and merging on the raw data. In some embodiments, passive gathering can be used to either manually or automatically monitor the latest related datasets and add the related databases to a candidate list, and proactive searching can be used to either manually or automatically address the bucket effect. In some embodiments, the data collection module 504 can also convert data that does not include QA data to VQA data using rules or auto-labeling tools. To help quantify the diversity, the data collection module 504 can use a similarity score metric to measure the relevance between a new data source and the current data pool according to equation (1), described above. In some embodiments, the data generator 115 can also perform data refinement on the acquired data, such as filtering, subset selection, data augmentation, and/or data formatting, described above in conjunction with FIG. 5.

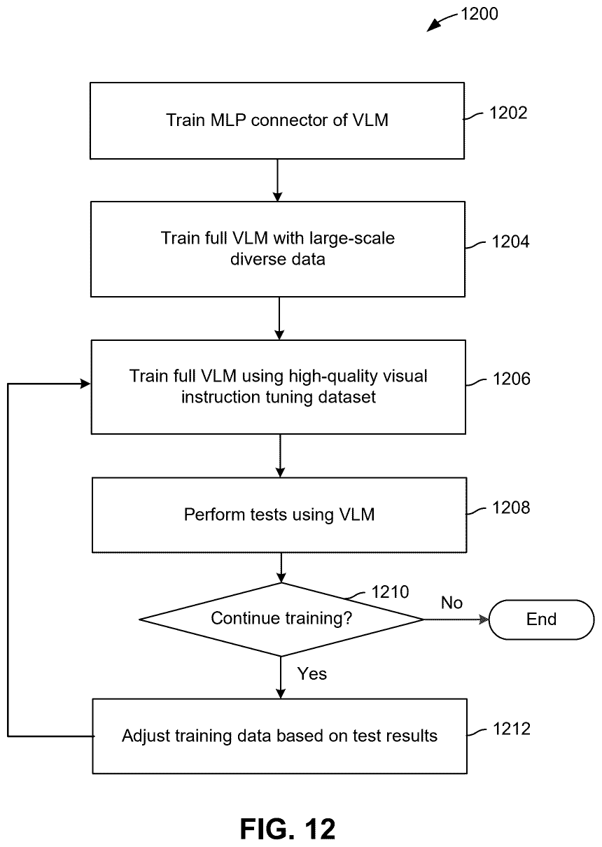

At step 1104, the data generator 115 stores the processed data from step 1102 in the data pool 506. Then, at step 1106, the model trainer 116 trains a VLM (e.g., VLM 150) using data in the data pool 506. In some embodiments, the model trainer 116 can train the VLM according to the steps discussed in greater detail below in conjunction with FIG. 12.

At step 1108, the data generator 115 performs tests using the trained VLM. In some embodiments, the tests can include one or more benchmark tests that test the performance of the VLM at various tasks, such as question answering, solving math problems, optical character recognition, etc. Any technically feasible tests can be used in some embodiments, which can include one or more tests that use a pre-trained VLM to judge answers by the VLM trained at step 1106.

At step 1110, if the data generator 115 determines that additional data is required to train the VLM, then the method 1100 returns to step 1102, where the data generator 115 collects, relevance filters, and merges additional data from one or more data sources. In some embodiments, the data generator 115 can determine whether additional data is required to train the VLM based on the results of the tests performed using the trained VLM at step 1108. For example, in some embodiments, additional data associated with tests that the VLM performed poorly on can be acquired.

On the other hand, if the data generator 115 determines that no additional data is required, then the method 1100 proceeds directly to step 1112. At step 1112, if the data generator 115 determines that data refinement is also not required, then the 1110 method ends. On the other hand, if the data generator 115 determines that data refinement is required before continuing to train the VLM, then the method 1100 continues to step 1114, where the data generator 115 performs data refinement. In some embodiments, the data generator 115 can determine whether data refinement is required to generate refined data for training the VLM based on the results of the tests performed using the trained VLM at step 1108. For example, in some embodiments, data refinement can be performed to generate additional data associated with tests that the VLM performed poorly. In some embodiments, the data refinement performed at step 1114 can include the filtering, subset selection, data augmentation, and/or data formatting described above in conjunction with FIG. 5.

After step 1114, the method 1100 returns to step 1104, where the data generator 115 stores the processed data from step 1114 in the data pool 506.

FIG. 12 is a flow diagram of method steps for training a VLM, according to various embodiments. Although the method steps are described in conjunction with the embodiments of FIGS. 1-10, persons skilled in the art will understand that any system configured to perform the method steps in any order falls within the scope of the present embodiments.

As shown, a method 1200 begins at step 1202, where the model trainer 116 trains the connector 414 of the VLM 150. As described, during stage 1 of training, the stage 1 training module 602 of the model trainer 116 trains the connector 414 of the VLM 150. Training the connector 414 can include updating parameters of the connector 414 while keeping other parameters of the VLM 150 fixed. Any technically feasible training algorithm can be used in some embodiments, such as backpropagation with gradient descent or a variation thereof.

At step 1204, the model trainer 116 trains the full VLM 150 with large-scale diverse data. As described, during stage 1.5 of training, the stage 1.5 training module 604 of the model trainer 116 trains the full VLM 150 with large-scale diverse data. In some embodiments, all data sources intended for visual instruction are used in stage 1.5, which can include introducing several other datasets that are not used in stage 2. In some embodiments, stage 1.5 can utilize a visual instruction dataset, and stage 2 can utilize a visual instruction tuning dataset. For example, in some embodiments, stage 2 can utilize training data belonging to the following categories: captioning and knowledge, mathematics, science, chart and table, naïve OCR, OCR QA, grounding and counting, general VQA, text-only, and stage 1.5 can utilize the same training data, as well as additional training data belonging to the captioning and knowledge, grounding and counting, and text-only categories.

In some embodiments, to speed up training, model trainer 116 can perform data packing using a balance-aware greedy knapsack technique that sorts samples in the training data set, initializes knapsacks, and then distributes the samples across the knapsacks, as described above in conjunction with Algorithm 1. Any technically feasible training algorithm can be used in some embodiments, such as backpropagation with gradient descent or a variation thereof.

At step 1206, the model trainer 116 trains the full VLM 150 using a high-quality visual instruction tuning dataset. As described, during stage 2 of training, the stage 2 training module 606 of the model trainer 116 trains the full VLM 150 using a high-quality visual instruction tuning dataset. Any technically feasible training algorithm can be used in some embodiments, such as backpropagation with gradient descent or a variation thereof.

At step 1208, the model trainer 116 performs tests using the VLM 150 that has been trained. In some embodiments, the tests can include one or more benchmark tests that test the performance of the VLM at various tasks, such as solving math problems, optical character recognition, etc. In some embodiments, the stage 2 training module 606 can perform tests using the VLM 150 that has been trained to determine whether to continue stage 2 of training.

At step 1210, the model trainer 116 determines whether to continue training 1210. In some embodiments, the model trainer 116 can determine whether to continue training based on results of the tests performed at step 1208. If the model trainer 116 determines not to continue training, then the method 1200 ends.

On the other hand, if the model trainer 116 determines to continue training, then the method 1200 continues to step 1212, where the model trainer 116 adjusts the training data based on the test results. For example, if the tests reveal that the trained VLM does not perform well on certain tasks, then the training data can be adjusted to include more data associated with such tasks and/or the training can sample data associated with such tasks more. Then, the method 1200 returns to step 1206, where the model trainer 116 trains the full VLM 150 with the high-quality visual instruction tuning dataset at stage 2 of training. Although only stage 2 of training is shown as being repeated for illustrative purposes, in some embodiments, stage 1.5 (i.e., step 1204) can also be repeated. For example, stage 1.5 could be iterated after iterating stage 2 for a number of times, such as more than 10 times.

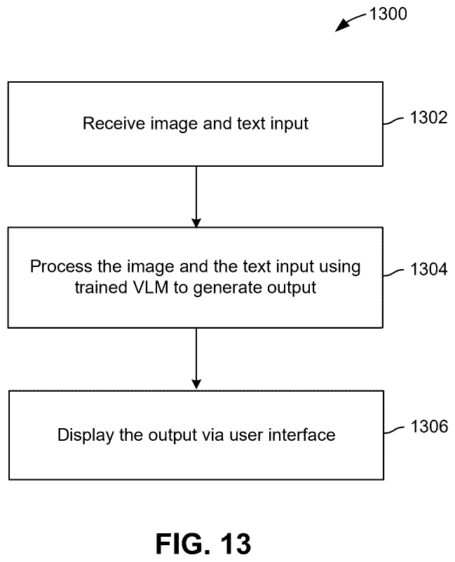

FIG. 13 is a flow diagram of method steps for processing inputs using a trained VLM, according to various embodiments. Although the method steps are described in conjunction with the embodiments of FIGS. 1-10, persons skilled in the art will understand that any system configured to perform the method steps in any order falls within the scope of the present embodiments.

As shown, a method 1300 begins at step 1302, where the application 146 receives an image and a text input. For example, the text input could be a question or instruction relating to the image.

At step 1304, the application 146 processes the image and the text input using the trained VLM 150 to generate an output. In some embodiments, the VLM 150 can include a mixture of vision encoders, an image splitting module, a feature concatenation module, a connector, and an LLM, as described above in conjunction with FIG. 4.

At step 1306, the application 146 displays the output via a UI. Although shown as displaying the output for illustrative purposes, in some embodiments, the application 146 can output and/or further process the output of the VLM 150 in any technically feasible manner. For example, in some embodiments, the application 146 can output the output of the VLM 150 as audio using a text-to-speech model and a speaker device.

In sum, techniques are disclosed for generating training data and training multimodal models. In some embodiments, a model trainer trains a VLM that includes an image splitting module that splits an input image into tiles, multiple vision encoders that encode the tiles into vision features, a feature concatenation module that concatenates the vision features, a connector that converts the concatenated features into language embeddings, and an LLM that takes as input the language embeddings and input text and that generates a natural language output. In some embodiments, a data generator first collects and refines data from various sources to generate training data for training a VLM. The refinements can include filtering the data, selecting subsets from the data, augmenting the data, and/or formatting the data. After the training data is generated, the model trainer performs training of the VLM in three stages. In the first stage of training, referred to herein as stage 1 training, the model trainer trains a connector of the VLM while keeping other portions of the VLM fixed. In the second stage of training, referred to herein as stage 1.5 training, the model trainer trains the full VLM with large-scale diverse data. In the third stage of training, referred to herein as stage 2 training, the model trainer trains the full VLM using a high-quality visual instruction tuning dataset. The training also employs a balance-aware greedy knapsack technique that prioritizes balanced length distribution over packing efficiency to improve the speed of training. Once trained, the VLM can take as input text and/or an image and output a natural language response.

At least one technical advantage of the disclosed techniques relative to the prior art is that, with the disclosed techniques, multimodal models, such as vision-language models, can be trained to generate correct responses to more user inputs relative to what can be generated using some conventional multimodal models. In addition, the disclosed techniques permit multimodal models to be trained more efficiently than conventional techniques for training multimodal models. These technical advantages represent one or more technological improvements over prior art approaches.

1. In some embodiments, a computer-implemented method for training a multimodal model comprises performing one or more first operations to train a connector disposed between one or more vision encoders and a language model included in the multimodal model, performing one or more second operations to train the multimodal model using a first dataset, and performing one or more third operations to train the vision language model using a second dataset to generate a trained multimodal model, wherein the second dataset is smaller than the first dataset, and wherein the trained multimodal model processes at least one of an input image or an input text to generate an output text.

2. The computer-implemented method of clause 1, wherein the one or more vision encoders are configured to encode image tiles generated by an image splitting module included in the multimodal model.

3. The computer-implemented method of clauses 1 or 2, further comprising generating at least part of the first dataset or the second dataset by performing at least one of automatically labeling image data, converting question-answer (QA) data into visual question-answer (VQA) data, clustering at least one of text data or image data, appending one or more instructions to at least one of text data or image data, adding one or more chain-of-thought (CoT) explanations to text data, or expanding one or more first answers into one or more second answers that are longer than the one or more first answers.

4. The computer-implemented method of any of clauses 1-3, further comprising generating at least one portion of the first dataset or the second dataset using another trained multimodal model.

5. The computer-implemented method of any of clauses 1-4, further comprising performing one or more balance-aware greedy knapsack operations to group together data included in at least one of the first dataset or the second dataset.

6. The computer-implemented method of any of clauses 1-5, further comprising performing a similarity-based search to identify first data to add to at least one of the first dataset or the second dataset, and updating the at least one of the first dataset or the second dataset to include the first data.

7. The computer-implemented method of any of clauses 1-6, wherein performing the similarity-based search comprises computing a similarity that is a product of an image similarity and a text similarity.

8. The computer-implemented method of any of clauses 1-7, wherein the first dataset comprises a visual instruction dataset, and wherein the second dataset comprises a visual instruction tuning dataset.

9. The computer-implemented method of any of clauses 1-8, wherein the multimodal model comprises a vision-language model.

10. The computer-implemented method of any of clauses 1-9, further comprising outputting the output text via at least one of a display device or a speaker device.

11. In some embodiments, one or more non-transitory computer-readable storage media include instructions that, when executed by at least one processor, cause the at least one processor to perform steps for training a multimodal model, the steps comprising performing one or more first operations to train a connector disposed between one or more vision encoders and a language model included in the multimodal model, performing one or more second operations to train the multimodal model using a first dataset, and performing one or more third operations to train the multimodal model using a second dataset to generate a trained multimodal model, wherein the second dataset is smaller than the first dataset, and wherein the trained multimodal model processes at least one of an input image or an input text to generate an output text.

12. The one or more non-transitory computer-readable storage media of clause 11, wherein the one or more vision encoders are included in a channel-concatenated mixture of vision encoders that are configured to encode image tiles.

13. The one or more non-transitory computer-readable storage media of clauses 11 or 12, wherein the instructions, when executed by the at least one processor, further cause the at least one processor to perform the step of generating at least part of the first dataset or the second dataset by performing at least one of automatically labeling image data, converting question-answer (QA) data into visual question-answer (VQA) data, clustering at least one of text data or image data, appending one or more instructions to at least one of text data or image data, adding one or more chain-of-thought (CoT) explanations to text data, or expanding one or more first answers into one or more second answers that are longer than the one or more first answers.

14. The one or more non-transitory computer-readable storage media of any of clauses 11-13, wherein the instructions, when executed by the at least one processor, further cause the at least one processor to perform the step of generating at least one portion of the first dataset or the second dataset using another trained multimodal model.

15. The one or more non-transitory computer-readable storage media of any of clauses 11-14, wherein the instructions, when executed by the at least one processor, further cause the at least one processor to perform the step of performing one or more balance-aware greedy knapsack operations to group together data included in at least one of the first dataset or the second dataset.

16. The one or more non-transitory computer-readable storage media of any of clauses 11-15, wherein the instructions, when executed by the at least one processor, further cause the at least one processor to perform the steps of performing a similarity-based search to identify first data to add to at least one of the first dataset or the second dataset, and updating the at least one of the first dataset or the second dataset to include the first data.

17. The one or more non-transitory computer-readable storage media of any of clauses 11-16, wherein the instructions, when executed by the at least one processor, further cause the at least one processor to perform the steps of performing one or more tests using the trained multimodal model to determine one or more results, updating the second dataset based on the one or more results to generate a third dataset, and performing one or more third operations to re-train the trained multimodal model using the third dataset to generate a re-trained multimodal model.

18. The one or more non-transitory computer-readable storage media of any of clauses 11-17, wherein the first dataset includes at least one of captioning and knowledge data, grounding and counting, or text data that is in addition to the second dataset.

19. The one or more non-transitory computer-readable storage media of any of clauses 11-18, wherein the one or more vision encoders include at least one of a convolutional encoder or a vision transformer (ViT) encoder.

20. In some embodiments, a system comprises one or more memories storing instructions, and one or more processors that are coupled to the one or more memories and, when executing the instructions, are configured to perform one or more first operations to train a connector disposed between one or more vision encoders and a language model included in a multimodal model, perform one or more second operations to train the multimodal model using a first dataset, and perform one or more third operations to train the multimodal model using a second dataset to generate a trained multimodal model, wherein the second dataset is smaller than the first dataset, and wherein the trained multimodal model processes at least one of an input image or an input text to generate an output text.

1. In some embodiments, a computer-implemented method for processing data comprises splitting an image into a plurality of tiles, encoding each of the plurality of tiles using a plurality of vision encoders to generate a plurality of vision features, wherein the plurality of vision encoders are trained to perform different tasks, generating one or more tokens based on the plurality of vision features, and processing the one or more tokens using a language model to generate a text output.

2. The computer-implemented method of clause 1, wherein the language model processes a text input along with the one or more tokens.

3. The computer-implemented method of clauses 1 or 2, wherein the plurality of vision encoders include at least one of a vision transformer (ViT) encoder or a convolutional encoder.

4. The computer-implemented method of any of clauses 1-3, wherein each of the plurality of vision encoders is trained to perform at least one of a vision language alignment task, a text recognition task, an object detection task, a semantic segmentation task, or an optical character recognition (OCR) task.

5. The computer-implemented method of any of clauses 1-4, wherein generating the one or more tokens comprises fusing the plurality of vision features to generate fused vision features, and processing the fused vision features using a connector to generate the one or more tokens.

6. The computer-implemented method of any of clauses 1-5, wherein fusing the plurality of vision features comprises performing a channel-wise concatenation of the plurality of vision features.

7. The computer-implemented method of any of clauses 1-6, wherein the connector comprises a multi-layer perceptron (MLP).

8. The computer-implemented method of any of clauses 1-7, further comprising downsampling one or more vision features included in the plurality of vision features.

9. The computer-implemented method of any of clauses 1-8, wherein the one or more tokens comprise one or more text embeddings.

10. The computer-implemented method of any of clauses 1-9, wherein the language model comprises a large language model (LLM).

11. In some embodiments, one or more non-transitory computer-readable storage media include instructions that, when executed by at least one processor, cause the at least one processor to perform steps for processing data, the steps comprising splitting an image into a plurality of tiles, encoding each of the plurality of tiles using a plurality of vision encoders to generate a plurality of vision features, wherein the plurality of vision encoders are trained to perform different tasks, generating one or more tokens based on the plurality of vision features, and processing the one or more tokens using a language model to generate a text output.

12. The one or more non-transitory computer-readable storage media of clause 11, wherein the language model processes a text input along with the one or more tokens.

13. The one or more non-transitory computer-readable storage media of clauses 11 or 12, wherein the plurality of vision encoders include at least one of a vision transformer (ViT) encoder or a convolutional encoder.

14. The one or more non-transitory computer-readable storage media of any of clauses 11-13, wherein each of the plurality of vision encoders is trained to perform at least one of a vision language alignment task, a text recognition task, an object detection task, a semantic segmentation task, or an optical character recognition (OCR) task.

15. The one or more non-transitory computer-readable storage media of any of clauses 11-14, wherein the one or more tokens comprise one or more text embeddings.

16. The one or more non-transitory computer-readable storage media of any of clauses 11-15, wherein generating the one or more tokens comprises fusing the plurality of vision features to generate fused vision features, and processing the fused vision features using a connector to generate the one or more tokens.

17. The one or more non-transitory computer-readable storage media of any of clauses 11-16, wherein the instructions, when executed by the at least one processor, further cause the at least one processor to perform the step of downsampling one or more vision features included in the plurality of vision features.

18. The one or more non-transitory computer-readable storage media of any of clauses 11-17, wherein the instructions, when executed by the at least one processor, further cause the at least one processor to perform the step of generating an audio output based on the text output.

19. The one or more non-transitory computer-readable storage media of any of clauses 11-18, wherein the instructions, when executed by the at least one processor, further cause the at least one processor to perform the step of displaying the text output via a display device.

20. In some embodiments, a system comprises one or more memories storing instructions, and one or more processors that are coupled to the one or more memories and, when executing the instructions, are configured to split an image into a plurality of tiles, encode each of the plurality of tiles using a plurality of vision encoders to generate a plurality of vision features, wherein the plurality of vision encoders are trained to perform different tasks, generate one or more tokens based on the plurality of vision features, and process the one or more tokens using a language model to generate a text output.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing data, the method comprising:
splitting an image into a plurality of tiles;
encoding each of the plurality of tiles using a plurality of vision encoders to generate a plurality of vision features, wherein the plurality of vision encoders are trained to perform different tasks;
generating one or more tokens based on the plurality of vision features; and
processing the one or more tokens using a language model to generate a text output.

2. The computer-implemented method of claim 1, wherein the language model processes a text input along with the one or more tokens.

3. The computer-implemented method of claim 1, wherein the plurality of vision encoders include at least one of a vision transformer (ViT) encoder or a convolutional encoder.

4. The computer-implemented method of claim 1, wherein each of the plurality of vision encoders is trained to perform at least one of a vision language alignment task, a text recognition task, an object detection task, a semantic segmentation task, or an optical character recognition (OCR) task.

5. The computer-implemented method of claim 1, wherein generating the one or more tokens comprises:
fusing the plurality of vision features to generate fused vision features; and
processing the fused vision features using a connector to generate the one or more tokens.

6. The computer-implemented method of claim 5, wherein fusing the plurality of vision features comprises performing a channel-wise concatenation of the plurality of vision features.

7. The computer-implemented method of claim 5, wherein the connector comprises a multi-layer perceptron (MLP).

8. The computer-implemented method of claim 1, further comprising downsampling one or more vision features included in the plurality of vision features.

9. The computer-implemented method of claim 1, wherein the one or more tokens comprise one or more text embeddings.

10. The computer-implemented method of claim 1, wherein the language model comprises a large language model (LLM).

11. One or more non-transitory computer-readable storage media including instructions that, when executed by at least one processor, cause the at least one processor to perform steps for processing data, the steps comprising:
splitting an image into a plurality of tiles;
encoding each of the plurality of tiles using a plurality of vision encoders to generate a plurality of vision features, wherein the plurality of vision encoders are trained to perform different tasks;
generating one or more tokens based on the plurality of vision features; and
processing the one or more tokens using a language model to generate a text output.

12. The one or more non-transitory computer-readable storage media of claim 11, wherein the language model processes a text input along with the one or more tokens.

13. The one or more non-transitory computer-readable storage media of claim 11, wherein the plurality of vision encoders include at least one of a vision transformer (ViT) encoder or a convolutional encoder.

14. The one or more non-transitory computer-readable storage media of claim 11, wherein each of the plurality of vision encoders is trained to perform at least one of a vision language alignment task, a text recognition task, an object detection task, a semantic segmentation task, or an optical character recognition (OCR) task.

15. The one or more non-transitory computer-readable storage media of claim 11, wherein the one or more tokens comprise one or more text embeddings.

16. The one or more non-transitory computer-readable storage media of claim 11, wherein generating the one or more tokens comprises:
fusing the plurality of vision features to generate fused vision features; and
processing the fused vision features using a connector to generate the one or more tokens.

17. The one or more non-transitory computer-readable storage media of claim 11, wherein the instructions, when executed by the at least one processor, further cause the at least one processor to perform the step of downsampling one or more vision features included in the plurality of vision features.

18. The one or more non-transitory computer-readable storage media of claim 11, wherein the instructions, when executed by the at least one processor, further cause the at least one processor to perform the step of generating an audio output based on the text output.

19. The one or more non-transitory computer-readable storage media of claim 11, wherein the instructions, when executed by the at least one processor, further cause the at least one processor to perform the step of displaying the text output via a display device.

20. A system, comprising:
one or more memories storing instructions; and
one or more processors that are coupled to the one or more memories and, when executing the instructions, are configured to:
split an image into a plurality of tiles,
encode each of the plurality of tiles using a plurality of vision encoders to generate a plurality of vision features, wherein the plurality of vision encoders are trained to perform different tasks,
generate one or more tokens based on the plurality of vision features, and
process the one or more tokens using a language model to generate a text output.
